(19) United States
(12) Patent Application Publication
(10) Pub. No.: US 2007/0176951 A1
(43) Pub. Date: Aug. 2, 2007

(54) Display control device

(75) Inventor: Hirofumi Kato, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/699,360

(22) Filed: Jan. 30, 2007

(30) Foreign Application Priority Data
Jan. 31, 2006 (JP) 2006-023180

(51) Int. Cl. G09G 5/02

(52) U.S. Cl. 345/699

(57) ABSTRACT

When the horizontal period is less than a lower limit threshold value in a state that an LCD panel is driven in an SVGA mode, a mode judging circuit judges the resolution of an image signal as VGA. When the horizontal period is above an upper limit threshold value in a state that the LCD panel is driven in a VGA mode, the mode judging circuit judges the resolution of the image signal as SVGA. Even when frequency modulation is applied to the input signal, the modulation is absorbed by the width between the lower limit threshold value and the upper limit threshold value, whereby the resolution of the image signal can be reliably judged. A control signal generating circuit controls the timing of driving the LCD panel in accordance with the resolution, whereby image signals of a plurality of different resolutions can be reliably displayed on the LCD panel.

### INCORPORATION BY REFERENCE

The present application claims priority under 35 U.S.C. §119 to Japanese Patent Application No. 2006-023180 filed on Jan. 31, 2006. The content of the application is incorporated herein by reference in its entirety.

### FIELD OF THE INVENTION

The present invention relates to a display control device for controlling the timing of driving a display device in accordance with a plurality of resolutions.

### BACKGROUND OF THE INVENTION

For example, in display devices input with digital signals such as a liquid crystal display, that is, an LCD panel, a plasma display panel (PDP), etc., timing controllers as control devices provided in these display devices drive the respective display devices on the basis of input digital signals from an external source.

For example, in an operating system (OS) such as Windows (registered trademark), VGA (Video Graphics Array, 640×480 lines) display as a basic display mode (graphic sub system) is common at system start-up or in the case where system trouble occurs. That is, in the case of an application for a PC, the graphic system is enriched and thus signal input corresponding to the display device being used can be performed. However, in the case of an application for a FA (Factory Automation), only a VGA mode signal can be output when system trouble or the like occurs because of limitations of the graphic system or the operating system, and thus it has been required to respond to the VGA display at the display device side.

For example, when the resolution of a display device is larger than that of VGA, that is, it corresponds to SVGA (Super Video Graphics Array) having higher fineness, and the resolution of an image signal contained in an input digital signal corresponds to VGA, the driving timing of the display device must be changed in accordance with the input digital signal. Therefore, it is required to provide a configuration for identifying the resolution corresponding to the image signal with respect to the input digital signal.

As the configuration for identifying the resolution as described above known is a configuration for counting the clock frequency of an input digital signal and identifying the resolution of an image signal on the basis of the counted clock frequency as disclosed in Japanese Laid-Open Patent Publication No. 2000-305544, for example.

In general, the resolution of the image signal contained in the input digital signal is judged on the basis of whether the clock frequency of the input digital signal exceeds a preset predetermined threshold value.

However, with respect to an interface for image display signals in a recent digital display system, a digital signal is subjected to frequency modulation by spread spectrum (frequency spreading) or the like in order to reduce electromagnetic interference (EMI) of electric waves, and then image data are input to a display device. In such a case, the horizontal frequency becomes a frequency (clock number) which differs for every display line, and thus it may differ for values above and below the threshold value for identifying the resolution.

Therefore, when an input signal whose frequency varies for every display line is judged on the basis of a predetermined threshold value, there is a risk that a normal display cannot be achieved by the display device.

The present invention has been carried out in view of the foregoing point, and has an object to provide a display control device that enables a display device to reliably display image signals for a plurality of different resolutions.

### SUMMARY OF THE INVENTION

The present invention is equipped with detecting means for detecting a horizontal period of a synchronous signal contained in an input signal from an external source; judging means for judging the resolution corresponding to an image signal contained in the input signal on the basis of the horizontal period detected by the detecting means; and control means for controlling the driving timing of the display device in accordance with the resolution judged by the judging means, wherein the judging means judges the resolution of the image signal as a second resolution smaller than a first resolution when the horizontal period is less than a predetermined lower limit threshold value in a state that the display device is driven in connection with the first resolution, and also judges the resolution of the image signal as the first resolution when the horizontal period is above a predetermined upper limit threshold value larger than the predetermined lower limit threshold value in a state that the display device is driven in connection with the second resolution.

By judging the resolution of the image signal as the second resolution when the horizontal period is less than the predetermined lower limit threshold value in a state that the display device is driven in connection with the first resolution and also judging the resolution of the image signal as the first resolution when the horizontal period is above the predetermined upper limit threshold value larger than the predetermined lower limit threshold value in a state that the display device is driven in connection with the second resolution even when frequency modulation is applied to the input signal, for example, the frequency modulation is absorbed by the width of the lower limit threshold value and the upper limit threshold value, so that the resolution of the image signal can be reliably judged. Furthermore, the timing of driving the display device is controlled in accordance with the resolution concerned by the control means, whereby the image signals of a plurality of different resolutions can be reliably displayed by the display device.

### BRIEF DESCRIPTION OF THE DRAWINGS

FIG. 1 is a block diagram showing a display control device according to an embodiment of the present invention,

FIG. 2 is a graph showing a judgment reference of the judging means of the display control device,

FIG. 3 is a timing chart showing the operation corresponding to a first resolution of the display control device,

FIG. 4 is a timing chart showing the operation corresponding to a second resolution of the display control device,

FIG. 5 is a graph showing clock numbers of the first resolution and the second resolution of the display control device, and

FIG. 6 is a block diagram showing a graphic system having the display control device.

### DETAILED DESCRIPTION OF THE PREFERRED EMBODIMENT

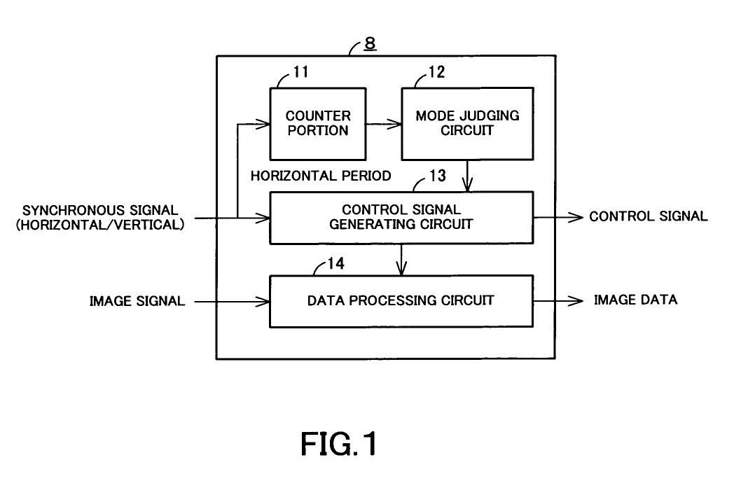

The construction of a display control device according to an embodiment of the present invention will be described with reference to FIGS. 1 to 6.

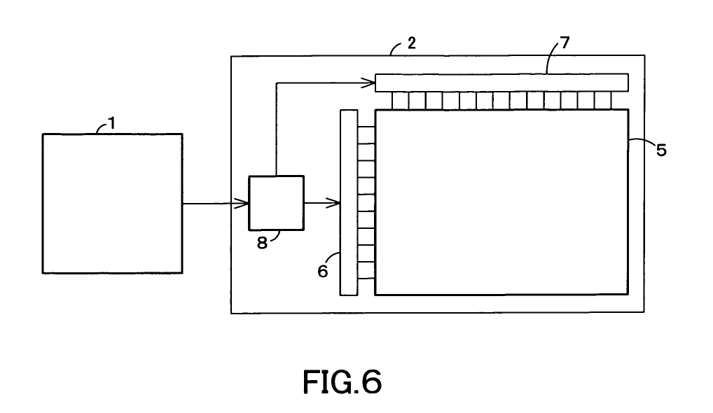

FIG. 6 shows a graphic system. In FIG. 6, 1 represents a computer, and the computer 1 is electrically connected via an interface (not shown) to an LCD panel 2 which is a liquid crystal display device as a display device.

The computer 1 contains a graphic chip (not shown) whose output side is electrically connected to the input side of the interface. Signals output from the graphic chip contain synchronous signals having a horizontal synchronous signal and a vertical synchronous signal, and an image signal displayed on the LCD panel 2.

Furthermore, the LCD panel 2 is an image display device as a display unit which can perform liquid crystal display and uses thin film transistors (TFT) as switching elements arranged in a matrix form. The LCD panel 2 is equipped with a gate driver 6 and a source driver 7 as driver circuits along the side edges and end edges of a rectangular display area 5. The gate driver 6 and the source driver 7 are electrically connected to the gate electrode and the source electrode of the thin film transistors respectively, whereby the operation of each thin film transistor can be controlled. Furthermore, in the LCD panel 2 is mounted a timing controller 8 as a display control device for switching the control timing of the gate driver 6 and the source driver 7 and outputting an image signal transmitted from the graphic chip of the computer 1 via the interface to the gate driver 6 and the source driver 7 at a predetermined timing. The LCD panel 2 is assumed to be compatible with SVGA (Super Video Graphics Array, 800×600 lines) as the first resolution, for example.

As shown in FIG. 1, the timing controller 8 is equipped with a counter portion 11 as detecting means to which the horizontal synchronous signal in the synchronous signal contained in the signal output from the computer 1 (FIG. 6) side is input, a mode judging circuit 12 as judging means which is electrically connected to the counter portion 11, a control signal generating circuit 13 as control means which is electrically connected to the mode judging circuit 12, and a data processing circuit 14 as signal processing means which is electrically connected to the control signal generating circuit 13.

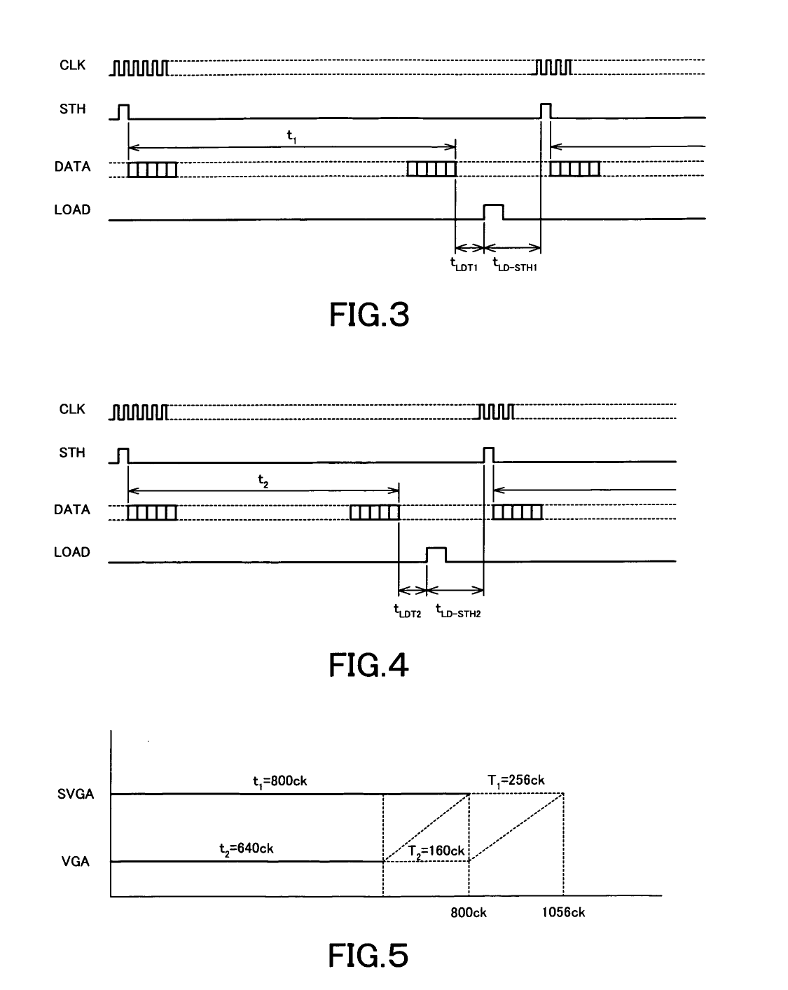

The counter portion 11 measures, that is, counts the clock (CLK) of the horizontal synchronous signal shown in FIGS. 3 and 4 to detect a horizontal period, and outputs it to the mode judging circuit 12 shown in FIG. 1.

The mode judging circuit 12 compares the horizontal period output from the counter portion 11 with the predetermined judgment reference value to judge whether the resolution of the image signal contained in the signal output from the computer 1 (FIG. 6) side is SVGA or VGA (Video Graphics Array, 640×480 lines) which is smaller in resolution than SVGA, that is, has lower fineness, in other words, has a second resolution providing a rough image.

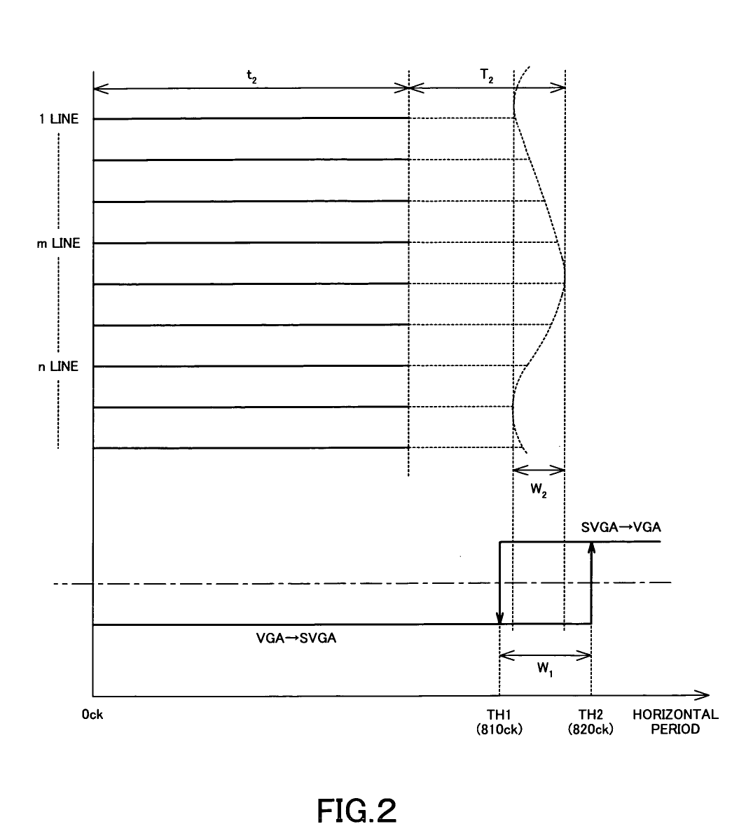

Furthermore, in the mode judging circuit 12, the judgment reference value for VGA and SVGA is brought with an hysteresis characteristic. That is, in the mode judging circuit 12, the judgment reference value at the switching time from SVGA to VGA is set to be different dependent on the driving state of the LCD panel 2 (FIG. 6) as shown in FIG. 2.

Here, as shown in FIGS. 3 and 4, by the time the graphic chip of the computer 1 (FIG. 6) outputs a horizontal start signal (STH) and then outputs a horizontal start signal (STH) of the next line, there is required a horizontal blanking period T₁, T₂ containing a timing after the last image signal is taken in, that is, a last data timing t_{LDT1}, t_{LDT2}, and a timing t_{LD-STH1}, t_{LD-STH2} from the falling of an analog output signal (LOAD) until the rising of the horizontal start signal (STH) of the next line in addition to a horizontal display period t₁, t₂, respectively.

As shown in FIG. 5, the horizontal period of standard SVGA is equal to 800+256=1056ck (ck: clock), and the horizontal period of standard VGA is equal to 640+160=800ck. Therefore, in the horizontal period of VGA, the lowest period required to drive SVGA is not satisfied. Therefore, the driving timing of the LCD panel 2 is switched in connection with the resolution of the signal in order to normally display VGA on the LCD panel 2 (FIG. 6).

Accordingly, a judgment reference when it is automatically identified from the horizontal period of the synchronous signal whether the resolution of the image signal contained in the signal from the computer 1 (FIG. 6) side is VGA or SVGA is based on whether an analog output signal LOAD when the LCD panel 2 (FIG. 6) is driven in the SVGA mode can be output or not.

Therefore, in the present embodiment, the lower limit threshold value TH1 as a reference value for the switching from SVGA to VGA is set to be larger than the sum of the horizontal Display period t₁, the last data timing t_{LDT1} and the timing t_{LD-STH1}. That is, TH1>t₁+t_{LDT1}+t_{LD-sTH1}. Furthermore, the upper limit threshold value TH2 as the reference value for the switching from VGA to SVGA is set to be larger than the lower limit threshold value TH1 by a predetermined width W₁. This width W₁ is set to be larger than the variation width W₂ of the horizontal period of VGA varied by the spread spectrum (frequency spreading) as shown in FIG. 2 in order to respond to electromagnetic interference (EMI) of electric waves, for example. In general, the variation width W₂ of the horizontal period of VGA is equal to 2, 3ck, and thus in the present embodiment, the width W₁ between the lower limit threshold value TH1 and the upper limit threshold value TH2 is set to 10ck, for example. That is, it is defined that TH2=TH1+10.

In the mode judging circuit 12, a line in one frame whose horizontal period is used for the judgment and a timing at which the judgment result concerned is reflected in the driving of the LCD panel 2 are arbitrarily set, and for example, there are various methods such as a method for judging VGA/SVGA on all the lines of one frame and switching the driving timing of the LCD panel 2 during the vertical blanking period on the basis of the judgment result, and a method for judging VGA/SVGA on a specific line and immediately switching the driving timing of the LCD panel 2 on the basis of the judgment result.

Returning to FIG. 1, the control signal generating circuit 13 outputs the control signal for the LCD panel 2 (FIG. 6) on the basis of the judgment result of the resolution in the mode judging circuit 12 and the synchronous signal contained in the signal output from the computer 1 (FIG. 6) side.

The data processing circuit 14 takes in and processes the image signal contained in the signal output from the computer 1 (FIG. 6) side on the basis of the output from the control signal generating circuit 13, and outputs the image data generated through the processing to the LCD panel 2 (FIG. 6) side.

Next, the display control method of the above embodiment will be described. In the following description, it is assumed that a signal of VGA is input to the LCD panel 2 compatible with SVGA.

First, the clock (CLK) of the horizontal synchronous signal out of the input signal output from the computer 1 side is counted by the counter portion 11 to detect the horizontal period of the input signal.

Subsequently, the resolution of the image signal contained in the input signal is judged in the mode judging circuit 12 on the basis of the horizontal period of the input signal detected in the counter portion 11.

For example, in a state that that the LCD panel 2 is driven in the SVGA mode, when the horizontal period detected by the counter portion 11 is less than the lower limit threshold value TH1, that is, less than 810ck, the resolution of the image signal is judged as VGA. When the horizontal period detected by the counter portion 11 is above the lower limit threshold value TH1, that is, above 810ck, the resolution of the image signal is judged as SVGA.

On the other hand, in a state that the LCD panel 2 is driven in the VGA mode, when the horizontal period detected by the counter portion 11 is less than the upper limit threshold value TH2, that is, less than 820ck, the resolution of the image signal is judged as VGA, and when the horizontal period detected by the counter portion 11 is above the upper limit threshold value TH2, that is, above 820ck, the resolution of the image signal is judged as SVGA.

Thereafter, the control signal generating circuit 13 generates and outputs the control signal for the LCD panel 2 on the basis of the judgment of the mode judging circuit 12 and the synchronous signal contained in the input signal from the computer 1 side, and also outputs the control signal for the data processing circuit 14 to the data processing circuit 14.

The data processing circuit 14 starts to take in the image signal for the source driver 7 (FIG. 6) on the basis of the output from the control signal generating circuit 13 after a horizontal start signal (STH) from the computer 1 side, and after the data transmission period of the horizontal display period t₁ or the horizontal display period t₂ is finished, the data processing circuit 14 generates the image data and outputs the data to the LCD panel 2 side.

Then, the gate driver 6 and the source driver 7 which are driven in the SVGA mode or the VGA mode turns on/off prescribed thin film transistors of the display area 5 on the basis of the image data output from the data processing circuit 14, whereby a predetermined image is displayed on the display areas 5.

As described above, in the above-described embodiment, when the horizontal period of the synchronous signal contained in the input signal is less than the lower limit threshold value TH1 in a state that the LCD panel 2 is driven in the SVGA mode, the mode judging circuit 12 judges the resolution of the image signal contained in the input signal as VGA, and when the horizontal period of the synchronous signal contained in the input signal is above the upper limit threshold value TH2 in a state that the LCD panel 2 is driven in the VGA mode, the mode judging circuit 12 judges the resolution of the image signal contained in the input signal as SVGA, that is, the hysteresis characteristic in which the threshold value for the switching between SVGA and VGA is different in accordance with the driving state of the LCD panel 2 is used for the judging reference value of the resolution in the mode judging circuit 12.

Therefore, for example, in a case where frequency modulation such as spread spectrum or the like is applied to the input signal in order to respond to the electromagnetic interference, if the judgment reference value is limited to one value like the related art, there is a risk that the resolution of the image signal cannot be accurately judged in accordance with the selection of the modulation width of the frequency and the judgment reference value. On the other hand, according to this embodiment, the effect of the frequency modulation is absorbed by the width W₁ between the lower limit threshold value TH1 and the upper limit threshold value TH2, the resolution of the image signal can be stably and reliably judged, and the control signal generating circuit 13 can control the timing of driving the LCD panel 2 in accordance with the resolution concerned, so that the image signal of a plurality of different resolutions can be reliably displayed on the LCD panel 2.

Furthermore, the width W₁ between the lower limit threshold value TH1 and the upper limit threshold value TH2 is set to be larger than the variation width W₂ of the horizontal period of the synchronous signal of the input signal to which the frequency modulation is applied by the spread spectrum or the like, whereby the judgment result of the resolution of the image signal in the mode judging circuit 12 can be reliably stabilized.

Still furthermore, the lower limit threshold value TH1 is set to be larger than the numerical value achieved by adding the horizontal display period t₁ corresponding to SVGA with the preset last data timing t_{LDT1} and the timing t_{LD-STH1}, whereby the judgment result of the resolution in the mode judging circuit 12 can be reliably stabilized irrespective of the timing of judging the resolution of the image signal by the mode judging circuit 12.

In particular, the image signal of different resolutions is supported at the LCD panel 2 side, and thus this embodiment can easily support even an application for a FA (Factory Automation) which does not have a sufficient graphic system unlike an application for a PC.

In the above-described embodiment, the LCD panel 2 compatible with SVGA is made to be compatible with VGA signals. However, by properly setting the lower limit threshold value TH1 and the upper limit threshold value TH2, this embodiment can be made to be compatible with signals of other resolutions such as Wide-VGA (800×480 lines), etc.

Furthermore, the LCD panel 2 is used as a display device in the above embodiment, however, the present invention applies to any display device such as an organic EL display device or the like.

What is claimed is:

1. A display control device comprising:
detecting means for detecting a horizontal period of a synchronous signal contained in an input signal from an external source;
judging means for judging the resolution corresponding to an image signal contained in the input signal on the basis of the horizontal period detected by the detecting means; and
control means for controlling the timing of a display device in connection with the resolution judged by the judging means, wherein
when the horizontal period is less than a predetermined lower limit threshold value in a state that the display device is driven in connection with a first resolution, the judging means judges the resolution of the image signal as a second resolution lower than the first resolution, and when the horizontal period is above a predetermined upper limit threshold value larger than the lower limit threshold value in a state that the display device is driven in connection with the second resolution, the judging means judges the resolution of the image signal as the first resolution.

2. The display control device according to claim 1, wherein
the width between the lower limit threshold value and the upper limit threshold value is set to be larger than the variation width of the horizontal period of the synchronous signal of the input signal.

3. The display control device according to claim 1, wherein
the lower limit threshold value is larger than a numerical value achieved by adding the horizontal display period corresponding to the first resolution with a preset predetermined value.

4. The display control device according to claim 1, wherein
the judging means judges the resolution of the image signal on the basis of the horizontal period of the synchronous signal corresponding to a prescribed line of the image signal of the input signal.

5. The display control device according to claim 1, wherein
the judging means judges the resolution of the image signal on the basis of the horizontal period of the synchronous signal corresponding to all the lines in one frame of the image signal of the input signal.
